(19) United States
(12) Patent Application Publication
(10) Pub. No.: US 2008/0000277 A1
(43) Pub. Date: Jan. 3, 2008

(54) Lock

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/785,440

(22) Filed: Apr. 18, 2007

(30) Foreign Application Priority Data
Jun. 30, 2006 (TW) 095124020
Aug. 24, 2006 (TW) 095131202
Dec. 26, 2006 (TW) 095149064

(51) Int. Cl. E05B 41/00

(52) U.S. Cl. 70/432

(57) ABSTRACT

A lock includes a lock core and an indicator. The lock core can be turned between a locking position and a releasing position. The indicator is connected to the lock core so that the indicator is in a first position when the lock core is in the locking position. The indicator is in a second position when the lock core is turned to the releasing position and returned to the locking position. The indicator is in a third position when the locked core is in the releasing position.

### BACKGROUND OF INVENTION

1. Field of Invention

The present invention relates to a lock and in particular to the lock for a trunk.

2. Related Prior Art

In early days, a trunk is equipped with a single lock. The lock can be turned to a releasing position from a locking position so that a button can be pushed to open the trunk. However, a user might forget to lock the trunk again after opening it.

A lock has been disclosed in Taiwanese Patent No. 586569 to include a lock core and an indicator. The indicator is connected to the lock core so that the status of the indicator is changeable corresponding to the lock core to indicate whether the lock core is in a locking position or a releasing position. Thus, a user can easily observe the status of the indicator to learn that of the lock core. This conventional lock is however operable by only one key held by the user so that a customs inspector cannot open a trunk without picking the lock.

There has been a trunk equipped with two locks. A customs inspector can turn the first lock to a releasing position with a universal key and pluck the universal key off the first lock. Then, the customs inspector can turn the second lock to a releasing position with the universal key and pluck the universal key off the second lock. Thus, the customs inspector can open the trunk. The customs inspector might forget to return the locks to their locking positions. However, an owner of the trunk has no way to know whether he or she has forgotten to lock the trunk in the first place or a customs inspector has forgotten to relock the trunk.

As disclosed in Taiwanese Patent Application No. 200639316, which has been published, a lock includes a shell with a window, a combination lock core, a key-operable lock core and an indicator. A user can only lock a trunk by operating the combination lock core. A customs inspector can only lock the trunk by operating the key-operable lock core with a key. When the customs inspector turns the key-operable lock core, the status of the indicator is changed so that an indicative zone of the indicator is exposed through the window. The indicator can however be turned between only two positions. In addition, the lock requires one indicator and at least “two” locking mechanisms, namely the combination lock core and the key-operable lock core, to function as a lock with status indication. Thus, the structure of this conventional lock is complicated.

The present invention is therefore intended to obviate or at least alleviate the problems encountered in prior art.

### SUMMARY OF INVENTION

The primary objective of the present invention to provide a lock with which a user can know whether he or she has forgotten to lock the trunk in the first place or a customs inspector has forgotten to lock the trunk.

According to the present invention, a lock includes a lock core and an indicator. The lock core can be turned between a locking position and a releasing position. The indicator is connected to the lock core. The indicator is in a first position when the lock core remains the locking position. The indicator is in a second position when the lock core is turned to the releasing position and returned to the locking position. The indicator is in a third position when the locked core is turned to the releasing position and remains in the releasing position.

Other objectives, advantages and features of the present invention will become apparent from the following description referring to the attached drawings.

### BRIEF DESCRIPTION OF DRAWINGS

The present invention will be described via detailed illustration of two embodiments referring to the drawings.

FIG. 1 is an exploded view of a lock according to the first embodiment of the present invention.

FIG. 2 is a cross-sectional view of the lock shown in FIG. 1.

FIG. 3 is a side view of a key inserted in a lock core of the lock shown in FIG. 2.

FIG. 4 is a front view of the lock core shown in FIG. 3.

FIG. 5 is a front view of the lock core in another position other than shown in FIG. 4.

FIG. 6 is a side view of another key inserted in the lock core shown in FIG. 2.

FIG. 7 is a front view of the lock core shown in FIG. 6.

FIG. 8 is a front view of the lock core in another position other than shown in FIG. 7.

FIG. 9 is an exploded view of a lock according to the second embodiment of the present invention.

FIG. 10 is a front view of a lock core of the lock shown in FIG. 9.

FIG. 11 is a cross-sectional view of the lock core shown in FIG. 10.

FIG. 12 is a front view of the lock core in another position other than shown in FIG. 10.

FIG. 13 is a cross-sectional view of the lock core shown in FIG. 12.

FIG. 14 is a front view of the lock core in another position other than shown in FIG. 12.

FIG. 15 is a cross-sectional view of the lock core shown in FIG. 14.

FIG. 16 is a front view of the lock core in another position other than shown in FIG. 14.

FIG. 17 is a cross-sectional view of the lock core shown in FIG. 16.

### DETAILED DESCRIPTION OF EMBODIMENTS

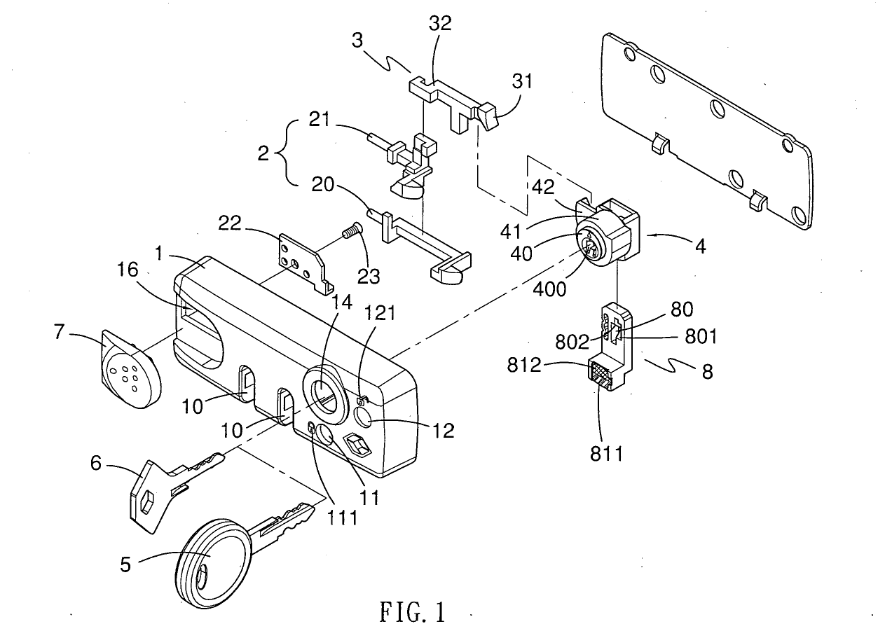

Referring to FIG. 1, according to a first embodiment of the present invention, a lock includes a shell 1, a latch set 2, a restraint element 3, a key-operable lock core 4, a control element 7 and an indicator 8. The lock is operable with either of a first key 5 and a second key 6. The first key 5 is held by a customs inspector for example while the second key 6 is held by an owner of the lock.

The shell 1 includes two apertures 10 defined therein, a first window 11 defined therein, a second window 12 defined therein, an opening 14 defined therein, a slot 16 defined therein, a first mark 111 provided thereon and a second mark 121 provided thereon. The first mark 111 is adjacent to the first window 11 to show a locking position of the key-operable lock core 4. The second mark 121 is adjacent to the second window 12 to show a releasing position of the key-operable lock core 4.

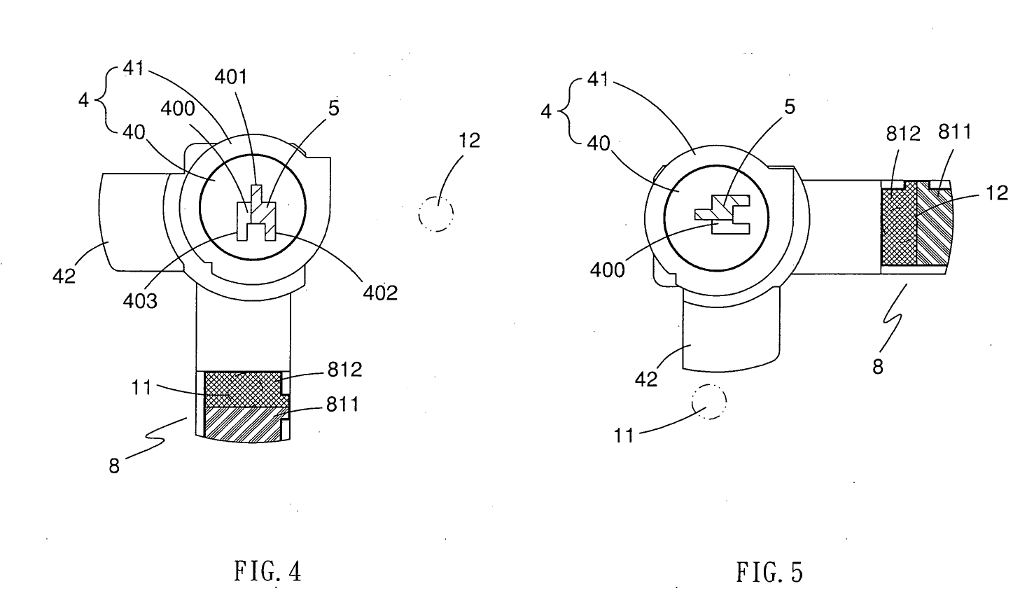

The key-operable lock core 4 includes a drum 41, a tumbler 40 rotationally disposed in the drum 41 and a rocker 42 connected to the tumbler 40. The tumbler 40 includes a keyhole 400 defined therein. Referring to FIG. 4, the keyhole 400 includes a first slot 401, a second slot 402 in communication with the first slot 401 and a third slot 403 in communication with the first slot 401. The key-operable lock core 4 is disposed in the shell 1 so that the keyhole 400 aligns to the opening 14.

The first key 5 can be inserted into the first and second slots 401 and 402 for turning the tumbler 40. The second key 6 can be inserted into the first and third slots 401 and 403 for turning the tumbler 40.

A first end 31 of the restraint element 3 is engaged with the rocker 42 when the key-operable lock core 4 is in the locking position. The first end 31 of the restraint element 3 is released from the rocker 42 when the key-operable lock core 4 is in the releasing position.

The latch set 2 includes a first latch 20, a second latch 21 and a carrier element 22 connected to both of the latches 20 and 21. The latches 20 and 21 are connected to a second end 32 of the restraint element 3. The latch set 2 is movably disposed in the shell 1.

The control element 7 is movably disposed on the shell 1. The control element 7 is connected to the carrier element 22 by a threaded bolt 23 inserted through the slot 16.

In use, two objects such as two pull tabs of one or two zippers of a trunk are inserted through the apertures 10. The control element 7 is moved so that the latches 20 and 21 are inserted through the pull tabs. The tumbler 40 is turned so that the key-operable lock core 4 is turned to the locking position from the releasing position. The restraint element 3 is locked by the rocker 42. The latches 20 and 21 are restrained by the restraint element 3.

The indicator 8 includes a slot 80 defined therein, a first indicative zone 811 provided thereon and a second indicative zone 812 provided thereon. A first slope 801 is formed at an end of the slot 80 while a second slope 802 is formed at an opposite end of the slot 80. The indicator 8 is movably inserted in the drum 41 so that the slot 80 is in communication with the keyhole 400.

The indicator 8 is changeable between four positions relative to the shell 1 as shown in Table 1.

TABLE 1

| Indicator | First Window | Second Window |
|---|---|---|
| First Position | First Indicative Zone | Blank |
| Second Position | Second Indicative Zone | Blank |
| Third Position | Blank | Second Indicative Zone |
| Fourth Position | Blank | First Indicative Zone |

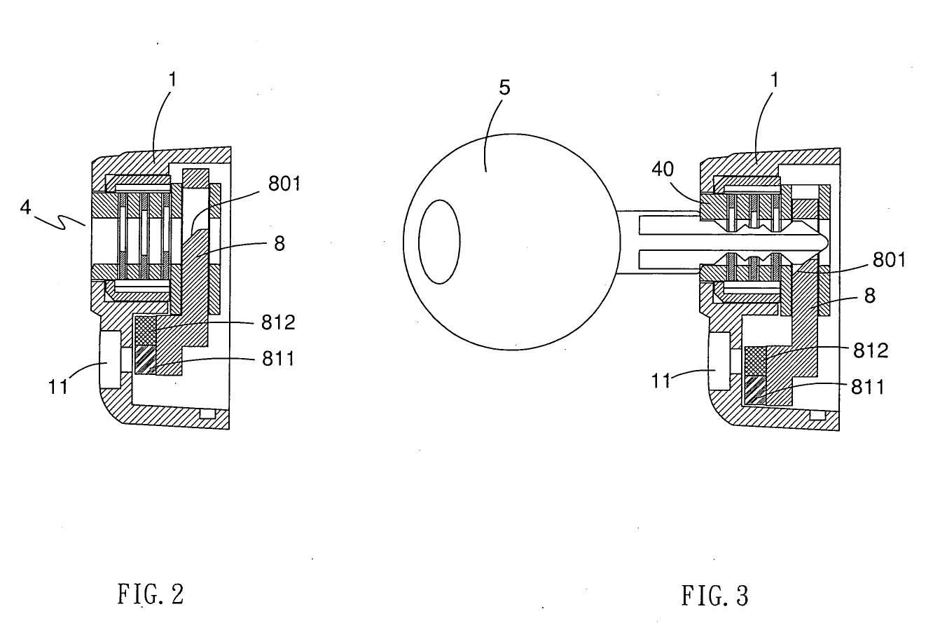

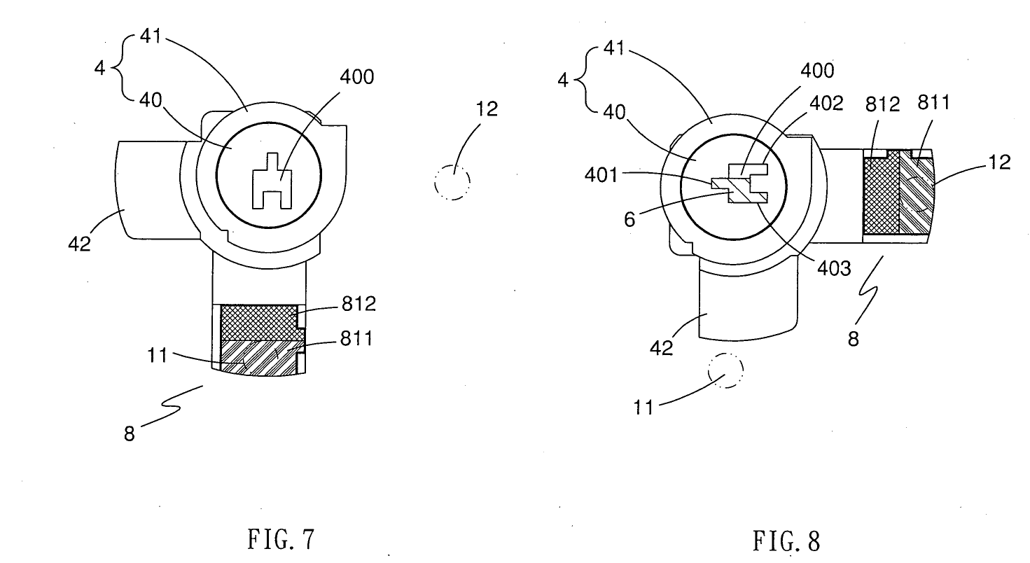

Referring to FIGS. 2 and 7, the key-operable lock core 4 is in the locking position. The first indicative zone 811 is exposed through the first window 11. The second window 12 is blank. The indicator 8 is in the first position.

Referring to FIGS. 3 and 4, the first key 5 is inserted in the first and second slots 401 and 402 against the first slope 801 so that the indictor 8 is lowered. Instead of the first indicative zone 811, the second indicator zone 812 is exposed through the first window 11. The second window 12 is blank. The indicator 8 is in the second position.

Referring to FIG. 5, the first key 5 is turned in a first direction so that the key-operable lock core 4 is turned to the releasing position. The indicator 8 is also turned so that the second indicator zone 812 is exposed through the second window 12 instead of the first window 11 that is now blank. The indicator 8 is in the third position.

The first key 5 may be turned in a second direction opposite to the first direction so that the key-operable lock core 4 is returned to the locking position. The indicator 8 is also turned so that the second indicator zone 812 is exposed through the first window 11 again. The indicator 8 is returned to the second position.

When the indicator 8 is in the first position, it is indicated that the first key 5 has never been inserted in the key-operable lock core 4. When the indicator 8 is in the second position, it is likely that the key-operable lock core 4 has been turned to the releasing position and returned to the locking position. When the indicator 8 is in the third position, it is indicated that the key lock 4 is turned to the releasing position with the first key 5 and left there.

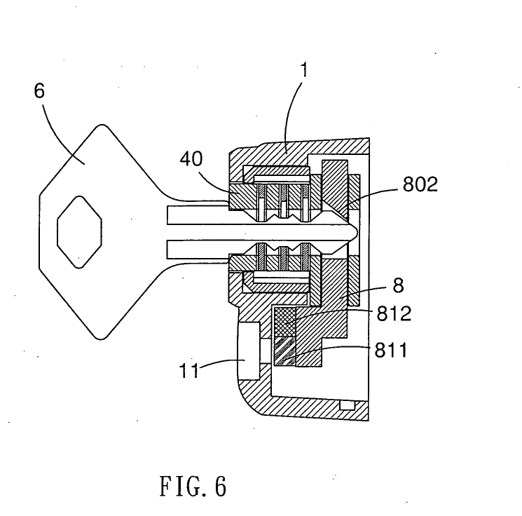

Referring to FIG. 6, to return the indicator 8 to the first position, the second key 6 is inserted into the first and third slots 401 and 403 against the second slope 802 so that the indicator 8 is moved. Referring to FIG. 8, instead of the second indicator zone 812, the first indicative zone 811 is exposed through the second window 12. The first window 11 is blank. The indicator 8 is in the fourth position. The second key 6 can be turned in the second direction so that the key-operable lock core 4 can be returned to the locking position as shown in FIG. 7.

The second key 6 can be inserted in the first and third slots 401 and 403 and turned in the first direction so that the key-operable lock core 4 can be turned to the releasing position. The indicator 8 is also turned so that the first indicative zone 811 is exposed through the second window 12 instead of the first window 11 as shown in FIG. 8.

As discussed in the two previous paragraphs, it is indicated that the second key 6 has been inserted in the first and third slots 401 and 403, and the key-operable lock core 4 is in the releasing position when the indicator 8 is in the fourth position.

Furthermore, if the indicator 8 is in the third position, the customs inspector who holds the first key 5 will be held responsible for leaving the key-operable lock core 4 in the releasing position. If the indicator 8 is in the fourth position, the owner will have to blame himself or herself for leaving the key-operable lock core 4 in the releasing position.

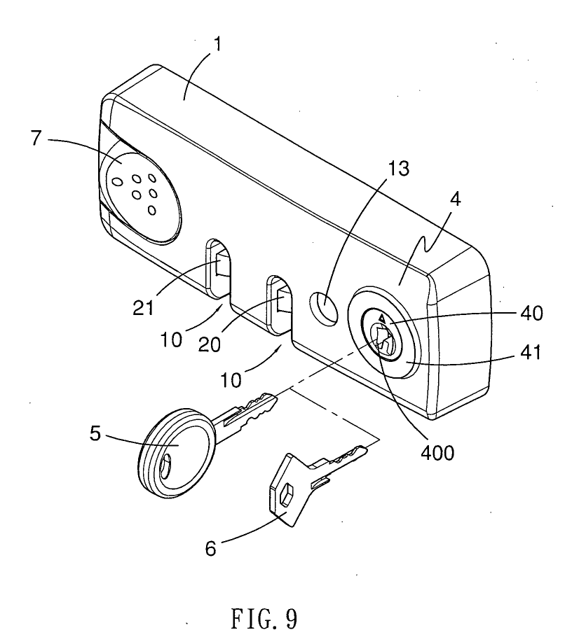

Referring to FIGS. 9 through 17, there is shown a lock according to a second embodiment of the present invention. The second embodiment is like the first embodiment except including only one window 13 instead of the windows 11 and 12 and an indicator set 9 instead of the indicator 8. In addition, contrary to the first embodiment, the first key 5 of the second embodiment can be inserted into the first and third slots 401 and 403 for turning the tumbler 40. The second key 6 can be inserted into the first and second slots 401 and 402 for turning the tumbler 40.

The indicator set 9 includes a first indicator 91, a guide 922 with a groove 923 for movably receiving the first indicator 91 and a second indicator 92 extending perpendicular to the guide 922. The first indicator 91 includes a slot 90 defined therein, a first indicative zone 911 formed thereon and a second indicative zone 912 formed thereon. A first slope 901 is formed at an end of the slot 90 while a second slope 902 is formed at an opposite end of the same. The slot 90 is in communication with the keyhole 400. The guide 922 and the second indicator 92 are formed together as one piece connected to the tumbler 40. An indicative zone 921 (“third indicative zone”) is attached to the second indicator 92.

The indicator set 9 is changeable between three positions relative to the shell 1 as shown in Table 2.

TABLE 2

| Indicator Set | Window |
|---|---|
| First Position | First Indicative Zone |
| Second Position | Second Indicative Zone |
| Third Position | Third Indicative Zone |

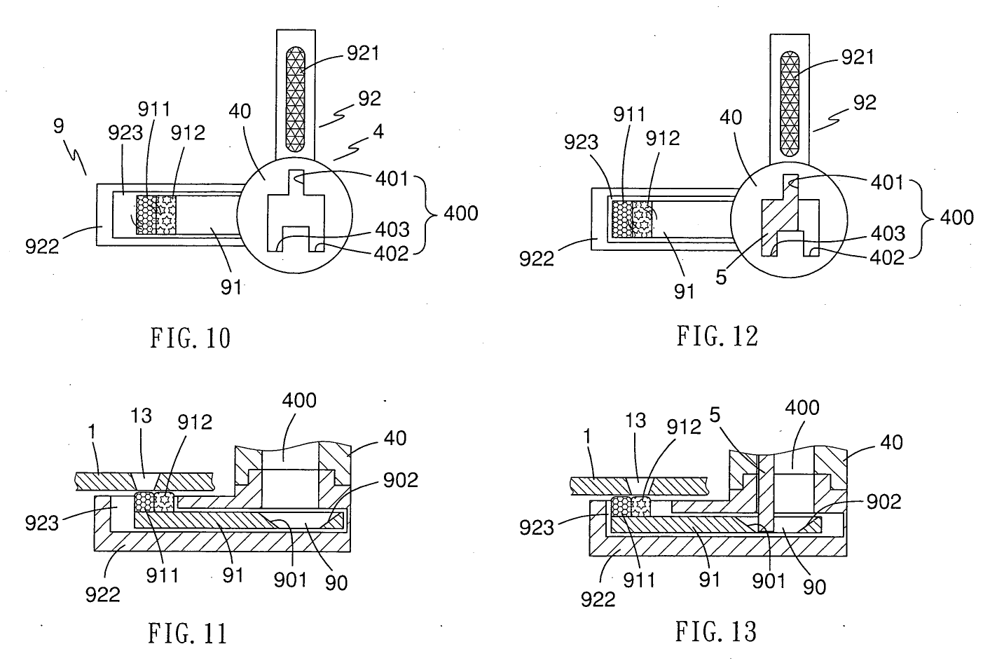

Referring to FIGS. 10 and 11, the key-operable lock core 4 is in the locking position so that the first indicative zone 911 is exposed through the window 13. The indicator set 9 is in the first position to indicate that the key-operable lock core 4 has never been turned to the releasing position by a customs inspector with the first key 5.

Referring to FIGS. 12 and 13, the first key 5 is inserted in the first and second slots 401 and 403 against the first slope 901 so that the indicator set 9 is moved to the left. Instead of the first indicative zone 911, the second indicative zone 912 is exposed through the window 13. The indicator set 9 is in the second position to indicate that the key-operable lock core 4 has been maneuvered.

Now, by inserting the second key 6 in the keyhole 400 against the second slope 902, the first indicator 91 is moved to a position shown in FIGS. 16 and 17 from the position shown in FIGS. 12 and 13. That is, the indicator set 9 is returned to the first position.

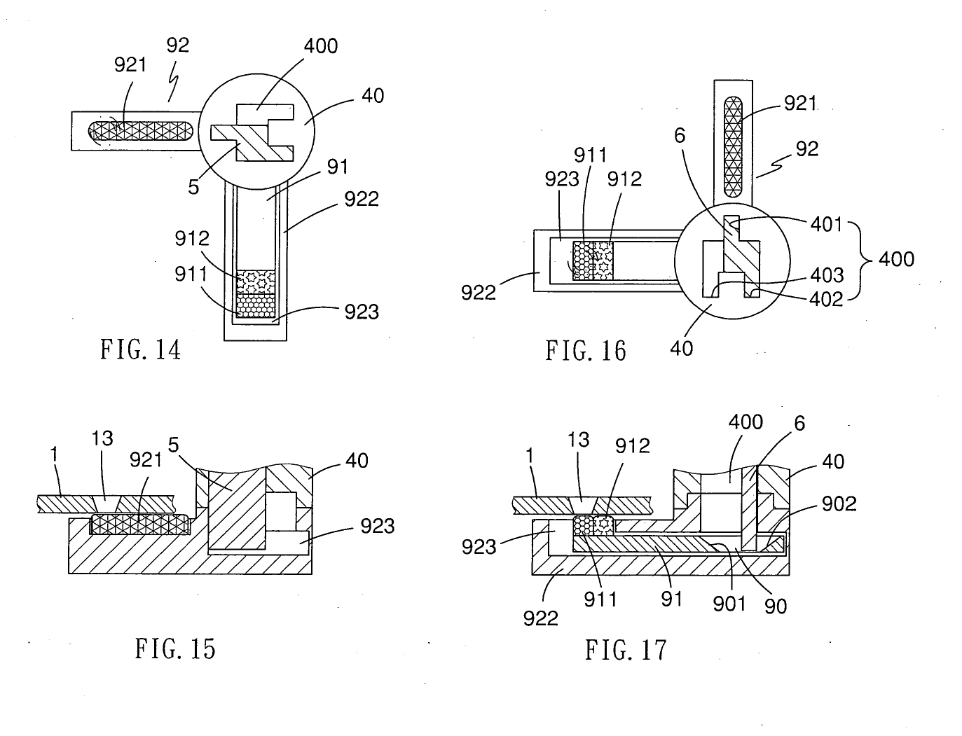

Referring to FIGS. 14 and 15, the first key 5 is turned in the first direction so that the key-operable lock core 4 is turned to the releasing position. The indicator set 9 is turned together with the tumbler 40. Instead of the second indicative zone 912, the third indicative zone 921 is exposed through the window 13. The indicator set 9 is in the third position to indicate that the key-operable lock core 4 has been turned to the releasing position by the first key 5 and left there.

Now, by inserting the second key 6 in the keyhole 400 against the second slope 902, the first indicator 91 is moved along the groove 923. Then, the second key 6 can be turned so that the indicator set 9 is returned to the first position.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A lock comprising:
a lock core changeable between a locking position and a releasing position; and
an indicator connected to the lock core so that the indicator is in a first position when the lock core remains in the locking position, and is in a second position when the lock core is turned to the releasing position and returned to the locking position, and is in a third position when the locked core is turned to the releasing position and remains in the releasing position.

2. The lock according to claim 1 wherein the indicator comprises a first indicative zone for indicating the first position, a second indicative zone for indicating the second position and a third indicative zone for indicating the third position.

3. The lock according to claim 2 comprising a shell for containing the lock core and the indicator, wherein the shell comprising a window for exposing a selective one of the first, second and third indicative zones.

4. The lock according to claim 2 wherein the lock core is a key-operable lock core so that the window exposes the second indicative zone instead of the first indicative zone when a key is inserted in the key-operable lock core, and exposes the third indicative zone instead of the second indicative zone when the key-operable lock core is turned to the releasing position by the key, and exposes the second indicative zone instead of the third indicative zone when the key-operable lock core is returned to the locking position by the key.

5. The lock according to claim 1 comprising a shell for containing the lock core and the indicator, wherein the shell comprises a first window and a second window, and the indicator comprises a first indicative zone exposed through the first window in the first position and a second indicative zone exposed through the first window in the second position and exposed through the second window in the third position.

6. The lock according to claim 5 wherein the lock core is a key-operable key lock so that the first window exposes the second indicative zone instead of the first indicative zone when a key is inserted in the key-operable lock core, and the second indicative zone is exposed through the second window when the key-operable lock core is turned to the releasing position by the key, and is exposed through the first window again when the key-operable lock core is returned to the locking position.

7. The lock according to claim 5 wherein the lock core is a key-operable lock core and the indicator is changeable between the first, second and third position by operating the lock core with a first key and changeable to a fourth position from the third position with a second key.

8. The lock according to claim 7 wherein the key-operable lock core can switch the indicator between the second and third positions by the first key and between the first and fourth positions by the second key.

9. The lock according to claim 1 wherein the lock core is a key-operable lock core so that the indicator is turned to the second position from the first position when a first key is inserted in the key-operable lock core, and is turned to the third position from the second position when the key-operable lock core is turned to the releasing position by the first key, and is returned to the second position from the third position when the key-operable lock core is returned to the locking position by the firs key.

10. The lock according to claim 9 wherein the key-operable lock core is operable by a second key, and the indicator is in the first position when the second key is inserted in the key-operable lock core.

11. The lock according to claim 10 wherein the indicator is returned to the first position from the third position when the second key is inserted in the key-operable lock core.

12. The lock according to claim 11 wherein the indicator can be switched to a fourth position from the third position and then to the first position by operating key-operable lock core with the second key.

13. The lock according to claim 12 wherein the indicator is turned to the fourth position from the first position when the key-operable lock core is turned to the releasing position by the second key, and is turned to the first position from the fourth position when the key-operable lock core is returned to the locking position by the second key.

14. The lock according to claim 1 wherein the lock core is operable by either of a first key and a second key.

15. The lock according to claim 1 wherein the lock core comprises a tumbler with a keyhole defined therein, the keyhole comprising a first slot, a second slot in communication with the first slot and a third slot in communication with the first slot so that a first key can be inserted in the first and second slots while a second key can be inserted in the first and third slots.

16. The lock according to claim 15 wherein the indicator comprises a slot defined therein and a first slope formed at an end of the slot so that the first key can be inserted into the keyhole against the first slope to turn the indicator to the second position from the first position.

17. The lock according to claim 16 wherein the indicator comprises a second slope formed at an opposite end of the slot so that the second key can be inserted into the keyhole against the second slope to return the indicator to the first position from the third position.

18. The lock according to claim 2 wherein the shell comprises at least one aperture for receiving an object, and the lock comprises:
at least one latch for locking the object;
a restraint element for connecting the latch to the lock core so that the lock core is operable to lock the latch; and
a control element connected to the latch so that the control element is operable to cause the latch to release the object.

19. The lock according to claim 5 wherein the shell comprises at least one aperture for receiving an object, and the lock comprises:
at least one latch for locking the object;
a restraint element for connecting the latch to the lock core so that the lock core is operable to lock the latch; and
a control element connected to the latch so that the control element is operable to cause the latch to release the object.

20. A lock comprising:
a key-operable lock core operable by either of a first key and a second key; and
an indicator changeable in position for indicating whether the key-operable lock core has been turned to a releasing position by the first key, and returnable by the second key.
